(19) United States
(12) Patent Application Publication
(10) Pub. No.: US 2011/0190008 A1
(43) Pub. Date: Aug. 4, 2011

(54) SYSTEMS, METHODS, AND APPARATUSES FOR PROVIDING CONTEXT-BASED NAVIGATION SERVICES

(75) Inventors: Antti Johannes ERONEN, Tampere (FI); Jussi Artturi LEPPANEN, Tampere (FI); Miska Matias HANNUKSELA, Ruutana (FI)

(73) Assignee: NOKIA CORPORATION, Espoo (FI)

(21) Appl. No.: 13/014,590

(22) Filed: Jan. 26, 2011

Related U.S. Application Data
(60) Provisional application No. 61/299,671, filed on Jan. 29, 2010.

(51) Int. Cl. G01C 21/00; H04W 4/02

(52) U.S. Cl. 455/456.3; 701/200

(57) ABSTRACT

Methods, apparatuses, and systems are provided for providing context-based navigation services. A method may include determining a first location and a second location. The method may further include extracting context information from a context model based at least in part upon one or more of the first location or the second location. The extracted context information may include one or more of audio context information, activity context information, social context information, or visual context information. The method may additionally include determining at least one route between the first location and the second location based at least in part upon the extracted context information. The method may also include providing the at least one determined route to a client apparatus. Corresponding apparatuses and systems are also provided.

### RELATED APPLICATION

This application claims priority to U.S. Application No. 61/299,671 filed Jan. 29, 2010, which is incorporated herein by reference in its entirety.

### TECHNOLOGICAL FIELD

Embodiments of the present invention relate generally to navigation technology and, more particularly, relate to systems, methods, and apparatuses for providing context-based navigation services.

### BACKGROUND

The modern computing era has brought about a tremendous expansion in computing power as well as increased affordability of computing devices. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor are becoming increasingly ubiquitous and are used for execution of a wide range of applications. For example, recent advances in processing power, battery life, and miniaturization of peripherals such as global positioning system (GPS) receivers have allowed for the incorporation of positioning functionality into mobile computing devices. Consequently, mobile computing devices are increasingly used by individuals for receiving mapping or navigation services in a mobile environment.

### BRIEF SUMMARY OF SOME EXAMPLES OF THE INVENTION

Systems, methods, apparatuses, and computer program products described herein provide context-based navigation services. The systems, methods, apparatuses, and computer program products provided in accordance with example embodiments of the invention may provide several advantages to network service providers, computing devices accessing network services, and computing device users. In this regard, systems, methods, apparatuses, and computer program products are provided that provide navigation services to a user based on context information. Example embodiments of the invention provide navigation services based on audio context information, activity context information, social context information, visual context information, time context information, and/or the like. Embodiments of the invention provide for collection of context information associated with one or more locations from client apparatuses. The collected context information is used in some example embodiments to generate a context model comprising activity contexts, audio contexts, social contexts, visual contexts, and/or the like associated with locations. Example embodiments of the invention utilize the context model to determine suggested navigation routes for users based upon a context(s) (e.g., activity context, audio context, social context, visual context, and/or the like) suggested to or requested by the user. Accordingly, users may receive more meaningful navigation services that may include routes selected by route context. These context-based navigation services may be particularly beneficial to pedestrian users and/or users engaging in other non-motorized travel, such as, for example, cyclists, skiers, and/or the like.

In a first example embodiment, a method is provided, which comprises determining a first location and a second location. The method of this embodiment further comprises extracting context information from a context model based at least in part upon one or more of the first location or the second location. The extracted context information of this embodiment comprises one or more of audio context information, activity context information, social context information, or visual context information. The method of this embodiment additionally comprises determining at least one route between the first location and the second location based at least in part upon the extracted context information. The method of this embodiment also comprises causing the at least one determined route to be provided to a client apparatus.

In another example embodiment, an apparatus is provided. The apparatus of this embodiment comprises at least one processor and at least one memory storing computer program code, wherein the at least one memory and stored computer program code are configured to, with the at least one processor, cause the apparatus to at least determine a first location and a second location. The at least one memory and stored computer program code are configured to, with the at least one processor, further cause the apparatus of this embodiment to extract context information from a context model based at least in part upon one or more of the first location or the second location. The extracted context information of this embodiment comprises one or more of audio context information, activity context information, social context information, or visual context information. The at least one memory and stored computer program code are configured to, with the at least one processor, additionally cause the apparatus of this embodiment to determine at least one route between the first location and the second location based at least in part upon the extracted context information. The at least one memory and stored computer program code are configured to, with the at least one processor, also cause the apparatus of this embodiment to cause the at least one determined route to be provided to a client apparatus.

In another example embodiment, a computer program product is provided. The computer program product of this embodiment includes at least one computer-readable storage medium having computer-readable program instructions stored therein. The program instructions of this embodiment comprise program instructions configured to determine a first location and a second location. The program instructions of this embodiment further comprise program instructions configured to extract context information from a context model based at least in part upon one or more of the first location or the second location. The extracted context information of this embodiment comprises one or more of audio context information, activity context information, social context information, or visual context information. The program instructions of this embodiment also comprise program instructions configured to determine at least one route between the first location and the second location based at least in part upon the extracted context information. The program instructions of this embodiment additionally comprise program instructions configured to cause the at least one determined route to be provided to a client apparatus.

In another example embodiment, an apparatus is provided that comprises means for determining a first location and a second location. The apparatus of this embodiment further comprises means for extracting context information from a context model based at least in part upon one or more of the first location or the second location. The extracted context information of this embodiment comprises one or more of audio context information, activity context information, social context information, or visual context information. The apparatus of this embodiment additionally comprises means for determining at least one route between the first location and the second location based at least in part upon the extracted context information. The apparatus of this embodiment also comprises means for causing an indication of the at least one determined route to be provided to a client apparatus.

In another example embodiment, a method is provided, which comprises determining a first location and a second location. The method of this embodiment further comprises causing an indication of the first location and the second location to be provided to a network navigation apparatus. The method of this embodiment additionally comprises receiving one or more routes between the first location and the second location. The one or more routes of this embodiment are determined based at least in part upon context information extracted from a context model. The context information of this embodiment comprises one or more of audio context information, activity context information, social context information, or visual context information.

In another example embodiment, an apparatus is provided. The apparatus of this embodiment comprises at least one processor and at least one memory storing computer program code, wherein the at least one memory and stored computer program code are configured to, with the at least one processor, cause the apparatus to at least determine a first location and a second location. The at least one memory and stored computer program code are configured to, with the at least one processor, further cause the apparatus of this embodiment to cause an indication of the first location and the second location to be provided to a network navigation apparatus. The at least one memory and stored computer program code are configured to, with the at least one processor, additionally cause the apparatus of this embodiment to receive one or more routes between the first location and the second location. The one or more routes of this embodiment are determined based at least in part upon context information extracted from a context model. The context information of this embodiment comprises one or more of audio context information, activity context information, social context information, or visual context information.

In another example embodiment, a computer program product is provided. The computer program product of this embodiment includes at least one computer-readable storage medium having computer-readable program instructions stored therein. The program instructions of this embodiment comprise program instructions configured to determine a first location and a second location. The program instructions of this embodiment further comprise program instructions configured to cause an indication of the first location and the second location to be provided to a network navigation apparatus. The program instructions of this embodiment additionally comprise program instructions configured to cause receipt of one or more routes between the first location and the second location. The one or more routes of this embodiment are determined based at least in part upon context information extracted from a context model. The context information of this embodiment comprises one or more of audio context information, activity context information, social context information, or visual context information.

In another example embodiment, an apparatus is provided that comprises means for determining a first location and a second location. The apparatus of this embodiment further comprises means for causing an indication of the first location and the second location to be provided to a network navigation apparatus. The apparatus of this embodiment additionally comprises means for receiving one or more routes between the first location and the second location. The one or more routes of this embodiment are determined based at least in part upon context information extracted from a context model. The context information of this embodiment comprises one or more of audio context information, activity context information, social context information, or visual context information.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a block diagram of a system for providing context-based navigation services according to an example embodiment of the present invention;

FIG. 2 is a schematic block diagram of a mobile terminal according to an example embodiment of the present invention;

FIG. 3 illustrates a block diagram of a client apparatus for providing context-based navigation services according to an example embodiment of the invention;

FIG. 4 illustrates a block diagram of a network navigation apparatus for providing context-based navigation services according to an example embodiment of the invention;

FIG. 5 illustrates a flowchart according to an example method for providing context-based navigation services according to an example embodiment of the invention;

FIG. 6 illustrates a flowchart according to an example method for providing context-based navigation services according to an example embodiment of the invention;

FIG. 7 illustrates a flowchart according to an example method for updating a context model according to an example embodiment of the invention; and

FIG. 8 illustrates a flowchart according to an example method for providing context information to a network navigation apparatus 104 according to an example embodiment of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

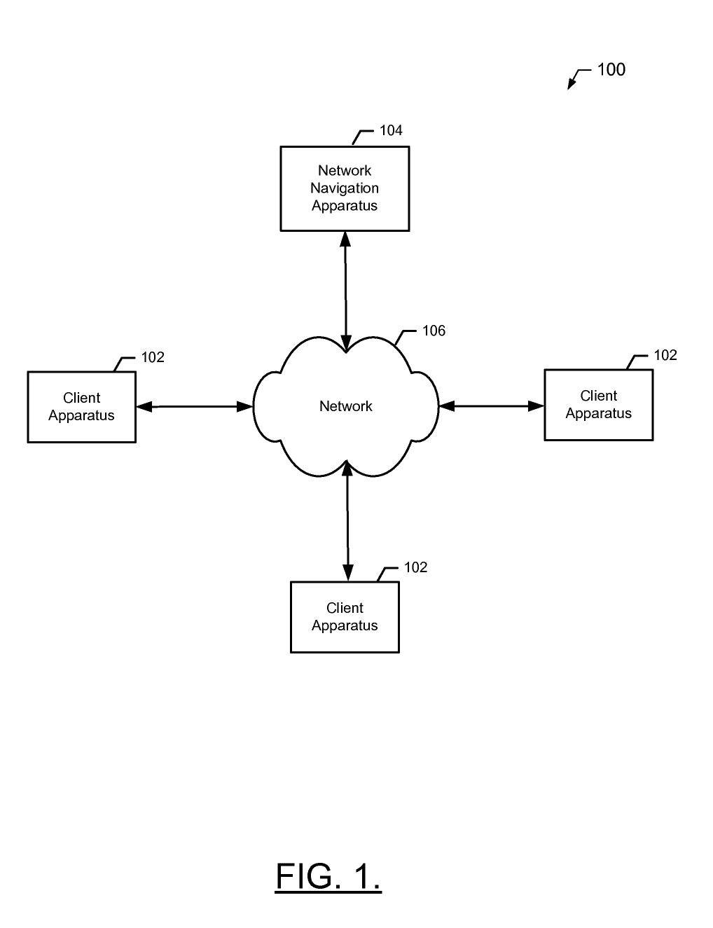

FIG. 1 illustrates a block diagram of a system 100 for providing context-based navigation services according to an example embodiment of the present invention. It will be appreciated that the system 100 as well as the illustrations in other figures are each provided as an example of one embodiment of the invention and should not be construed to narrow the scope or spirit of the invention in any way. In this regard, the scope of the invention encompasses many potential embodiments in addition to those illustrated and described herein. As such, while FIG. 1 illustrates one example of a configuration of a system for providing context-based navigation services, numerous other configurations may also be used to implement embodiments of the present invention.

In at least some embodiments, the system 100 includes a network navigation apparatus 104 and a plurality of client apparatuses 102. The network navigation apparatus 104 may be in communication with one or more client apparatuses 102 over the network 106. The network 106 may comprise a wireless network (e.g., a cellular network, wireless local area network, wireless personal area network, wireless metropolitan area network, and/or the like), a wireline network, or some combination thereof, and in some embodiments comprises at least a portion of the internet.

The network navigation apparatus 104 may be embodied as one or more servers, one or more desktop computers, one or more laptop computers, one or more mobile computers, one or more network nodes, multiple computing devices in communication with each other, any combination thereof, and/or the like. In this regard, the network navigation apparatus 104 may comprise any computing device or plurality of computing devices configured to provide context-based navigation services to one or more client apparatuses 102 over the network 106 as described herein.

The client apparatus 102 may be embodied as any computing device, such as, for example, a desktop computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), any combination thereof, and/or the like. In this regard, the client apparatus 102 may be embodied as any computing device configured to ascertain a position of the client apparatus 102 and access context-based navigation services provided by the network navigation apparatus 104 over the network 106 so as to facilitate navigation by a user of the client apparatus 102.

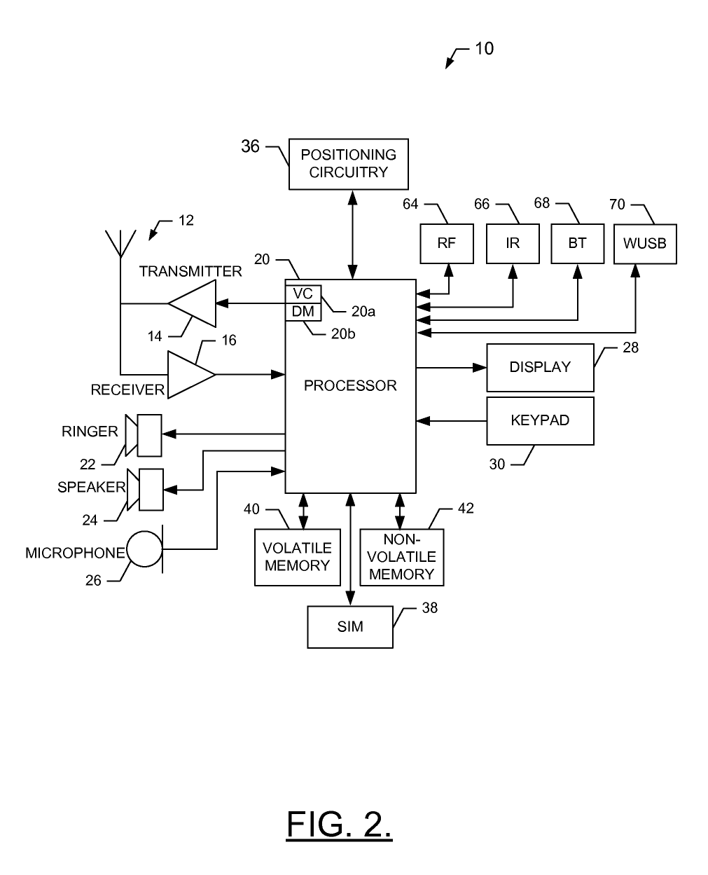

In an example embodiment, the client apparatus 102 is embodied as a mobile terminal, such as that illustrated in FIG. 2. In this regard, FIG. 2 illustrates a block diagram of a mobile terminal 10 representative of one embodiment of a client apparatus 102 in accordance with embodiments of the present invention. It should be understood, however, that the mobile terminal 10 illustrated and hereinafter described is merely illustrative of one type of client apparatus 102 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wireless Fidelity (Wi-Fi) or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, IEEE 802.15 techniques, IEEE 802.16 techniques, and/or the like.

In addition, the mobile terminal 10 in some embodiments includes positioning circuitry 36. The positioning circuitry 36 may include, for example, a global positioning system (GPS) sensor, an assisted global positioning system (Assisted-GPS) sensor, a Bluetooth (BT)-GPS mouse, other GPS or positioning receivers, or the like. However, in one exemplary embodiment, the positioning circuitry 36 may include an accelerometer, pedometer, or other inertial sensor. In this regard, the positioning circuitry 36 may be capable of determining a location of the mobile terminal 10, such as, for example, longitudinal and latitudinal directions of the mobile terminal 10, or a position relative to a reference point such as a destination or start point. Further, the positioning circuitry 36 may determine the location of the mobile terminal 10 based upon signal triangulation or other mechanisms. As another example, the positioning circuitry 36 may be capable of determining a rate of motion, degree of motion, angle of motion, and/or type of motion of the mobile terminal 10, such as may be used to derive activity context information. Information from the positioning sensor 136 may then be communicated to a memory of the mobile terminal 10 or to another memory device to be stored as a position history or location information.

The mobile terminal 10 may comprise memory, such as a subscriber identity module (SIM) 38, a universal subscriber identity module (USIM), a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

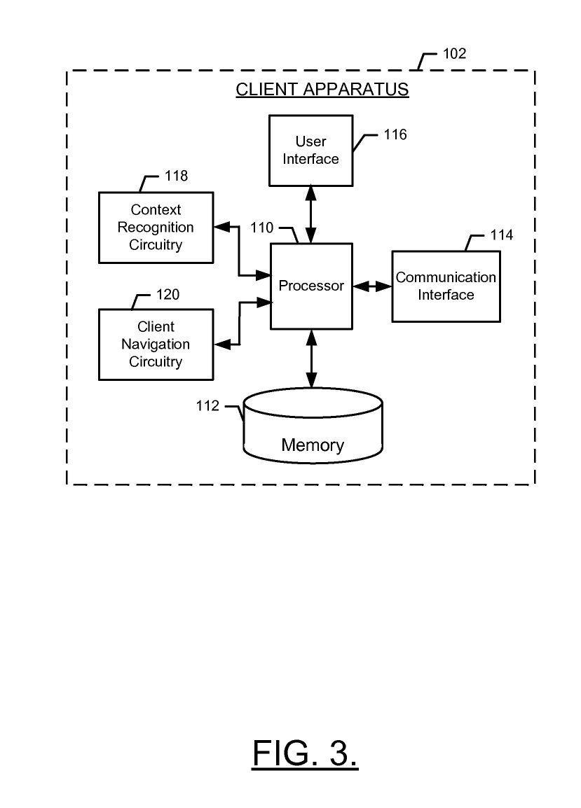

Referring now to FIG. 3, FIG. 3 illustrates a block diagram of a client apparatus 102 for providing context-based navigation services according to an example embodiment of the invention. In the example embodiment illustrated in FIG. 3, the client apparatus 102 may include various means, such as a processor 110, memory 112, communication interface 114, user interface 116, context recognition circuitry 118, and coordination circuitry 120 for performing the various functions herein described. These means of the client apparatus 102 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example, memory 112) that is executable by a suitably configured processing device (for example, the processor 110), or some combination thereof.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some embodiments the processor 110 comprises a plurality of processors. The plurality of processors may be in operative communication with each other and may be collectively configured to perform one or more functionalities of the client apparatus 102 as described herein. In embodiments wherein the client apparatus 102 is embodied as a mobile terminal 10, the processor 110 may be embodied as or comprise the processor 20. In an example embodiment, the processor 110 is configured to execute instructions stored in the memory 112 or otherwise accessible to the processor 110. These instructions, when executed by the processor 110, may cause the client apparatus 102 to perform one or more of the functionalities of the client apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. Although illustrated in FIG. 3 as a single memory, the memory 112 may comprise a plurality of memories. In various embodiments, the memory 112 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the client apparatus 102 is embodied as a mobile terminal 10, the memory 112 may comprise the volatile memory 40 and/or the non-volatile memory 42. The memory 112 may be configured to store information, data, applications, instructions, or the like for enabling the client apparatus 102 to carry out various functions in accordance with example embodiments of the present invention. For example, in at least some embodiments, the memory 112 is configured to buffer input data for processing by the processor 110. Additionally or alternatively, in at least some embodiments, the memory 112 is configured to store program instructions for execution by the processor 110. The memory 112 may store information in the form of static and/or dynamic information. This stored information may be stored and/or used by the context recognition circuitry 118 and/or client navigation circuitry 120 during the course of performing their functionalities.

The communication interface 114 may be embodied as any device or means embodied in circuitry, hardware, a computer program product comprising computer readable program instructions stored on a computer readable medium (for example, the memory 112) and executed by a processing device (for example, the processor 110), or a combination thereof that is configured to receive and/or transmit data from/to an entity of the system 100, such as, for example, a network navigation apparatus 104. In at least one embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more entities of the system 100. The communication interface 114 may be configured to receive and/or transmit data using any protocol that may be used for communications between entities of the system 100. The communication interface 114 may additionally be in communication with the memory 112, user interface 116, context recognition circuitry 118 and/or client navigation circuitry 120, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. The user interface 116 may be in communication with the memory 112, communication interface 114, context recognition circuitry 118, and/or client navigation circuitry 120, such as via a bus.

The context recognition circuitry 118 may be embodied as various means, such as circuitry, hardware, a computer program product comprising computer readable program instructions stored on a computer readable medium (for example, the memory 112) and executed by a processing device (for example, the processor 110), or some combination thereof and, in one embodiment, is embodied as or otherwise controlled by the processor 110. The context recognition circuitry 118 may comprise and/or be in communication with one or more context sensors such that the context recognition circuitry 118 may receive context sensory data collected by the context sensors. The context sensors may comprise, for example, a positioning sensor, such as a GPS receiver. Additionally or alternatively, the context sensors may comprise an accelerometer, pedometer, gyroscope, and/or other inertial sensor configured to detect movement of the client apparatus 102. In embodiments wherein the client apparatus 102 is embodied as a mobile terminal 10, the context recognition circuitry 118 may comprise and/or be in communication with the positioning circuitry 36. As another example, the context sensors may comprise a microphone (e.g., the microphone 26) for capturing audio data. As a further example, the context sensors may comprise a camera, video camera, or the like for capturing images and/or videos. The context sensors may additionally or alternatively comprise proximity detection means that may be configured to detect people and/or other computing devices proximate to the client apparatus 102. The proximity detection means may, for example, comprise a Bluetooth transceiver (e.g., the Bluetooth transceiver 68), which may be configured to detect other Bluetooth enabled devices within Bluetooth communication range of the client apparatus 102. In embodiments wherein the context recognition circuitry 118 is embodied separately from the processor 110, the context recognition circuitry 118 may be in communication with the processor 110. The context recognition circuitry 118 may further be in communication with one or more of the memory 112, communication interface 114, user interface 116, or client navigation circuitry 120, such as via a bus.

The client navigation circuitry 120 may be embodied as various means, such as circuitry, hardware, a computer program product comprising computer readable program instructions stored on a computer readable medium (for example, the memory 112) and executed by a processing device (for example, the processor 110), or some combination thereof and, in one embodiment, is embodied as or otherwise controlled by the processor 110. In embodiments wherein the client navigation circuitry 120 is embodied separately from the processor 110, the client navigation circuitry 120 may be in communication with the processor 110. The client navigation circuitry 120 may further be in communication with one or more of the memory 112, communication interface 114, user interface 116, or context recognition circuitry 118, such as via a bus.

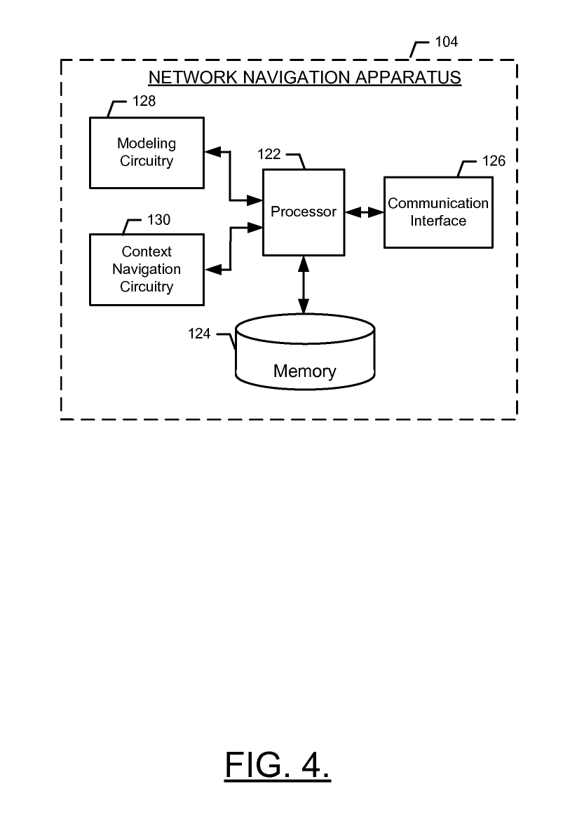

FIG. 4 illustrates a block diagram of a network navigation apparatus 104 for providing context-based navigation services according to an example embodiment of the invention. In the example embodiment illustrated in FIG. 4, the network navigation apparatus 104 may include various means, such as a processor 122, memory 124, communication interface 126, modeling circuitry 128, and context navigation circuitry 130 for performing the various functions herein described. These means of the network navigation apparatus 104 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example, memory 124) that is executable by a suitably configured processing device (for example, the processor 122), or some combination thereof.

The processor 122 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 4 as a single processor, in some embodiments the processor 122 comprises a plurality of processors. The plurality of processors may be in operative communication with each other and may be collectively configured to perform one or more functionalities of the network navigation apparatus 104 as described herein. The plurality of processors may be embodied on a single computing device or may be distributed across a plurality of computing devices collectively configured to perform one or more functionalities of the network navigation apparatus 104 as described herein. In an example embodiment, the processor 122 is configured to execute instructions stored in the memory 124 or otherwise accessible to the processor 122. These instructions, when executed by the processor 122, may cause the network navigation apparatus 104 to perform one or more of the functionalities of the network navigation apparatus 104 as described herein. As such, whether configured by hardware or software methods, or by a combination thereof, the processor 122 may comprise an entity capable of performing operations according to embodiments of the present invention while configured accordingly. Thus, for example, when the processor 122 is embodied as an ASIC, FPGA or the like, the processor 122 may comprise specifically configured hardware for conducting one or more operations described herein. Alternatively, as another example, when the processor 122 is embodied as an executor of instructions, such as may be stored in the memory 124, the instructions may specifically configure the processor 122 to perform one or more algorithms and operations described herein.

The memory 124 may comprise, for example, volatile memory, non-volatile memory, or some combination thereof. Although illustrated in FIG. 4 as a single memory, the memory 124 may comprise a plurality of memories. The plurality of memories may be embodied on a single computing device or distributed across a plurality of computing devices that may collectively comprise the network navigation apparatus 104. In various embodiments, the memory 124 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 124 may be configured to store information, data, applications, instructions, or the like for enabling the network navigation apparatus 104 to carry out various functions in accordance with example embodiments of the present invention. For example, in at least some embodiments, the memory 124 is configured to buffer input data for processing by the processor 122. Additionally or alternatively, in at least some embodiments, the memory 124 is configured to store program instructions for execution by the processor 122. The memory 124 may store information in the form of static and/or dynamic information. This stored information may be stored and/or used by modeling circuitry 128 and/or context navigation circuitry 130 during the course of performing their functionalities.

The communication interface 126 may be embodied as any device or means embodied in circuitry, hardware, a computer program product comprising computer readable program instructions stored on a computer readable medium (for example, the memory 124) and executed by a processing device (for example, the processor 122), or a combination thereof that is configured to receive and/or transmit data from/to an entity of the system 100, such as, for example, a client apparatus 102. In at least one embodiment, the communication interface 126 is at least partially embodied as or otherwise controlled by the processor 122. In this regard, the communication interface 126 may be in communication with the processor 122, such as via a bus. The communication interface 126 may include, for example, an antenna, a transmitter, a receiver, a transceiver and/or supporting hardware or software for enabling communications with one or more entities of the system 100. The communication interface 126 may be configured to receive and/or transmit data using any protocol that may be used for communications between entities of the system 100 over the network 106. The communication interface 126 may additionally be in communication with the memory 124, modeling circuitry 128, and/or context navigation circuitry 130, such as via a bus.

The modeling circuitry 128 may be embodied as various means, such as circuitry, hardware, a computer program product comprising computer readable program instructions stored on a computer readable medium (for example, the memory 124) and executed by a processing device (for example, the processor 122), or some combination thereof and, in one embodiment, is embodied as or otherwise controlled by the processor 122. In embodiments wherein the modeling circuitry 128 is embodied separately from the processor 122, the modeling circuitry 128 may be in communication with the processor 122. The modeling circuitry 128 may further be in communication with the memory 124, communication interface 126, and/or context navigation circuitry 130, such as via a bus.

The context navigation circuitry 130 may be embodied as various means, such as circuitry, hardware, a computer program product comprising computer readable program instructions stored on a computer readable medium (for example, the memory 124) and executed by a processing device (for example, the processor 122), or some combination thereof and, in one embodiment, is embodied as or otherwise controlled by the processor 122. In embodiments wherein the context navigation circuitry 130 is embodied separately from the processor 122, the context navigation circuitry 130 may be in communication with the processor 122. The context navigation circuitry 130 may further be in communication with the memory 124, communication interface 126, and/or modeling circuitry 128, such as via a bus.

In example embodiments, the context recognition circuitry 118 is configured to capture sensory data. This sensory data may be captured directly by the context recognition circuitry 118 and/or may be captured indirectly by one or more sensors, modules, or other elements in communication with the context recognition circuitry 118. The sensory data may, for example, comprise audio captured with a microphone. Accordingly, environmental noises that may be heard by a user of the client apparatus 102 at the location at which the client apparatus 102 is located may be captured. The sensory data may additionally or alternatively comprise an accelerometer signal defining movement of the client apparatus 102. As another example, the sensory data may comprise an indication of a number of electronic devices within signaling range of a proximity-based communications technology. For example, the context recognition circuitry 118 may comprise or be in communication with a Bluetooth module. The Bluetooth module may be configured to detect other Bluetooth enabled computing devices within range (e.g., the range of Bluetooth communication signals) of the client apparatus 102.

The context recognition circuitry 118 may be configured to capture sensory data constantly. As another example, the context recognition circuitry 118 may be configured to capture sensory data periodically. As a further example, the context recognition circuitry 118 may be configured to capture sensory data when the client apparatus 102 has moved to a location that is at least a predefined distance from a location at which the client apparatus 102 was located the most recent previous time sensory data was captured. In some embodiments, the context recognition circuitry 118 may be configured to capture sensory data when a context-based navigation program is activated or in use on the client apparatus 102. As yet another example, the context recognition circuitry 118 may be configured to capture sensory data when some other program is activated or used. As a specific example, the context recognition circuitry 118 may capture sensory data when an image is captured with the camera application. In this example, textual tags inputted by users to their images may comprise additional captured sensory data.

In example embodiments, the context recognition circuitry 118 is configured to derive context information from the sensory data and cause the derived context information to be transmitted to the network navigation apparatus 104. For example, the context recognition circuitry 118 may analyze a pattern of movement defined by an accelerometer signal to determine activity context information describing an activity in which a user of the client apparatus 102 is engaged. This activity may, for example, comprise walking, jogging, running, bicycling, skateboarding, skiing, and/or the like. In one example, the analyzing the accelerometer signal comprises one or more operations of preprocessing the accelerometer signal to reduce noise; taking the magnitude of a three-axis accelerometer signal to ignore the mobile device orientation, calculating features from the accelerometer signal; and inputting the features into a classifier to determine the activity. Feature extraction may, for example, comprise windowing the accelerometer signal, taking a Discrete Fourier Transform (DFT) of the windowed signal, and extracting features from the DFT. In one example, the features extracted from the DFT include for example one or more spectrum power values, power spectrum centroid, or frequency-domain entropy. In addition to features based on the DFT, the context recognition circuitry 118 may extract features from the time-domain accelerometer signal. These time-domain features may include, for example, mean, standard deviation, zero crossing rate, 75% percentile range, interquartile range, and/or the like. Using the features, a classifier used by the context recognition circuitry 118 may be trained to classify between the activities. In this regard, the context recognition circuitry 118 may be configured to implement and/or utilizes one or more classifiers, including, for example decision trees, support vector machines, naïve Bayes, k-Nearest Neighbor, and/or the like.

As another example, the context recognition circuitry 118 may be configured to perform activity context recognition based on fluctuation of signal strength to one or more cellular service towers (e.g., one or more GSM, LTE, LTE-Advanced, 3G, and/or the like base transceiver stations). Additionally or alternatively, the context recognition circuitry 118 may be configured to perform activity recognition based at least in part on a speed obtained from a GPS sensor. As another example, the context recognition circuitry 118 may perform activity context recognition based on a fusion of sensory information captured from multiple sensors.

The process of implementing an activity recognizer may comprise the operations of collecting accelerometer signals and/or other sensory information from the desired set of activities to be used as training data, extracting a set of characteristic features from the training data, and implementing a classifier using the training data. In addition, the process may involve performing feature selection to optimize the performance of the system on a set of training data. In the on-line operation stage, the context recognition circuitry 118 may extract the same features and input them into the classifier to determine the activity.

As another example, the context recognition circuitry 118 may be configured to analyze captured audio to determine audio context information. Audio context information may describe general characteristics of the captured audio, such as energy, loudness, or spectrum. Audio context information may also identify one or more audio events describing audible sounds present in the location at which the audio was captured. Such audio events may comprise, for example, human noise, conversation, vehicle noise, animal noise, construction noise, running water, and/or the like. Audio events may comprise continuous noises or sounds that last for the whole duration of the captured audio or events that have a specific start and end time in the captured audio (e.g., last for a partial duration of the captured audio). One or more audio events may be extracted from a certain input audio clip. It is also possible that no audio events are extracted from an input audio clip, for example if a confidence value is too low. Furthermore, the same event may also occur in the input audio clip multiple times. The context recognition circuitry 118 may be configured to determine audio context information by any applicable method for audio analysis. In one example, the context recognition circuitry 118 may be configured to identify audio events contained within captured audio using at least one model, such as, for example, a Gaussian mixture model (GMM), hidden Markov model (HMM), and/or the like. In one example, identifying audio events and determining audio context information comprises extracting a set of features from the audio signal, calculating a likelihood of a model of each audio event having generated the features, and selecting the audio event corresponding to the model resulting in the largest likelihood. An off-line training stage may be performed to obtain these models for each of a subset of audio events. In the off-line training stage, the same features may be extracted from a number of examples of each of a subset of sound events, and a model may be trained for each sound event class using the respective features. Various other methods can also be used, including classification using support vector machines, decision trees, hierarchical or non-hierarchical classifiers, and/or the like. Furthermore, in one example the identification may comprise comparing the likelihood of each audio event against at least one predetermined threshold, and identifying an audio event only if the at least one predetermined threshold is exceeded. Various features may be applied to this purpose, including, but not limited to, mel-frequency cepstral coefficients (MFCC), features described in the Moving Pictures Expert Group (MPEG) 7 standard such as Audio Spectrum Flatness, Spectral Crest Factor, Audio Spectrum Envelope, Audio Spectrum Centroid, Audio Spectrum Spread, Harmonic Spectral Centroid, Harmonic Spectral Deviation, Harmonic Spectral Spread, Harmonic Spectral Variation, Audio Spectrum Basis, Audio Spectrum Projection, Audio Harmonicity or Audio Fundamental Frequency, spectral power or energy values, linear prediction coefficients (LPC), any transformation of the LPC coefficients such as reflection coefficients or line spectral frequencies, zero-crossing rate, crest factor, temporal centroid, onset duration, envelope amplitude modulation, and/or the like.

The features may be indicative of the audio bandwidth. The features may comprise spectral roll-off features indicative of the skewness of the spectral shape of the audio signal. The features may be indicative of the change of the spectrum of the audio signal such as the spectral flux. The features may also comprise any combination of any of the features described herein and/or similar features not explicitly described herein. The features may also comprise a transformed set of features obtained by applying a transformation such as Principal Component Analysis, Linear Discriminant Analysis or Independent Component Analysis to any combination of features to obtain a transformed set of features with lower dimensionality and desirable statistical properties such as uncorrelatedness or statistical independence. The features may comprise the feature values measured in adjacent frames. To elaborate, the features may comprise, for example, a K+1 by T matrix of spectral energies, where K+1 is the number of spectral bands and T the number of analysis frames of the audio clip. The features may also comprise any statistics of the features, such as the mean value and standard deviation calculated over all the frames. The features may additionally comprise statistics calculated in segments of arbitrary length over the audio clip, such as mean and variance of the feature vector values in adjacent one-second segments of the audio clip. The features may further comprise dynamic features calculated as derivatives of different order over time of one or more features. In one embodiment, the extraction of the features comprises windowing the audio signal, taking a short-time discrete Fourier transform at each window, and extracting at least one feature based on the transform. In one embodiment, the event identification comprises detecting onsets from the audio signal, extracting features from a portion of the audio signal following each detected onset, and recognizing audio events corresponding to each onset.

In one embodiment, the identifying audio events and determining audio context information comprises calculating distances to a predetermined number of example sound events or audio contexts. In this embodiment, models are not trained for audio context but each audio context or sound event may be represented with a certain number of representative examples. When analyzing the captured audio, the context recognition circuitry 118 may subject the captured audio to feature analysis. The context recognition circuitry 118 may follow the feature analysis by performing distance calculation(s) between the features extracted from the captured audio and the stored example features. The context recognition circuitry 118 may determine dominant sound events or audio context for a certain location based on the dominant sound event or audio context within a predetermined number of nearest neighbors of the captured audio.

As another example, the context recognition circuitry 118 may be configured to analyze captured images or video to determine visual context information identifying one or more visual attributes and/or objects describing general characteristics of the image or physical objects present in the location at which the image or video was captured. Such image characteristics or objects may comprise, for example, colors, brightness, humans, vehicles, animals, plants, buildings, gadgets, statues, and so on. The analysis of captured images may be based on various image analysis approaches, such as computer vision, scene understanding, object recognition, template matching, gradient histograms, or pattern recognition. In one example, the analysis may comprise an object recognition step preceded by an object detection and/or segmentation step. In another example, a search window may be shifted over an input image and the object in the windows may be recognized with a classifier. In another example, a set of binary classifiers may be used, one for each object category. In this example, the classifier may separate one class of objects from all other objects. Various classifiers, such as a support vector machine (SVM), may be used for separating a class of objects. In another example, a nearest neighbor based approach may be used with very large labeled image databases, which may, for example, be of the order of 10⁸ to 10⁹ reference images. In this approach, each image may be represented as a color image of reduced size, such as 32 by 32 pixels. When the input image is recognized, it may be resampled to 32 by 32 pixel resolution and a distance may be calculated to the stored and labeled reference images. The recognized object and/or scene may be determined by majority voting among a certain number of nearest neighbors to the input image. The distance metric may comprise, for example, a sum of squared differences or another distance metric which may take into account for example translations and scaling. Further examples of visual context information which the context recognition circuitry 118 may be configured to extract include e.g. the amount of light, whether it is cloudy or clear, capture settings of the camera, and/or the like.

In some embodiments, the context recognition circuitry 118 may not fully derive context information from captured sensory data. Instead, the context recognition circuitry 118 may cause transmission of raw captured sensory data to the network navigation apparatus 104 in a format suitable for transmission over the network 106. For example, the context recognition circuitry 118 may cause transmission of captured audio data using an Adaptive Multi-Rate (AMR) coding, or any other appropriate coding. As another example, the context recognition circuitry 118 may pre-process captured sensory data to derive information that may be interpreted by the network navigation apparatus 104 such that the network navigation apparatus 104 may derive context information from information received from the client apparatus 102. Embodiments wherein captured sensory data and/or pre-processed captured sensory data rather than fully derived context information is transmitted to the network navigation apparatus 104 may allow for leveraging greater (e.g., more powerful) computational resources that may, in some embodiments, be available at the network navigation apparatus 104 as compared to the client apparatus 102. In this regard, leveraging more powerful computational resources may allow the use of more complex and better performing methods for activity recognition and/or audio context recognition.

As privacy concerns may be posed with some captured sensory data, such as, for example, captured audio data, the context recognition circuitry 118 may be configured to process captured sensory data to derive information that may preserve a user's privacy while preserving data needed for the network navigation apparatus 104 to derive context information. For example, the context recognition circuitry 118 may be configured to extract a plurality of feature vectors from captured audio data. Each feature vector may be denoted as xᵢ, where the subscript i=1, . . . , M, and M is the number of feature vectors. The context recognition circuitry 118 may randomize an order of the feature vectors before causing transmission of the feature vectors to the network navigation apparatus 104 for derivation of context information. In this regard, the context recognition circuitry 118 may select a first random vector xₖ from the sequence of feature vectors for transmission to the network navigation apparatus 104 and may continue to randomly select subsequent feature vectors from the remaining vectors for transmission until all feature vectors are uploaded to the network navigation apparatus 104. Accordingly, when the feature vectors are transmitted in a randomized order, a party eavesdropping on the transmission may be unable to reassemble the audio data to recognize a conversation contained within the originally captured audio data.

As another example, the context recognition circuitry 118 may be configured to extract social context information describing the number and/or other characteristics of people surrounding a client apparatus 102. For example, the context recognition circuitry 118 may be configured to derive an estimated number of people in the general vicinity of the client apparatus 102. This estimate may be made, for example, based on a number of electronic devices detected within a proximate range of the client apparatus 102, such as through Bluetooth transmissions. As a further example, the context recognition circuitry 118 may collect other characteristics such as gender, nationality, occupation, hobbies, social background, or other characteristics of nearby people. The characteristics may be obtained, for example, by communicating with the devices of the nearby people or communicating with a centralized database storing user profile information. As a further example, social context information may also be derived using other sensors of a client apparatus 102, such as a microphone, camera, and/or the like. For example, the context recognition circuitry 118 might analyze the captured audio to determine the gender of nearby people, or analyze captured images to assist in determining or to determine the number of people.

The context recognition circuitry 118 may be configured to derive other context information in addition to the aforementioned examples of audio context information, activity context information, visual context information, and social context information. For example, the context recognition circuitry 118 may be configured to derive time context information defining a time, date, season and/or the like at which sensory data was captured. This additional context information may be transmitted to the network navigation apparatus 104.

The context recognition circuitry 118 may be configured to create new context labels based on sensory data, context information, textual labels, and/or the like transmitted to the network navigation apparatus 104. The sensory data, context information, and/or textual labels may be uploaded to the service by the users. As an example, when context data is collected from the camera application, the context recognition circuitry 118 may create new context labels based on the textual tags inputted by the users to the images. For example, if many of the images in a certain area contain the text “horse back riding”, the context recognition circuitry may determine that “horse back riding” is a relevant new activity for the location. In one example, the determination of a relevant new activity involves calculating a distance to previously collected sensory data, and creating a new activity or environment if the distance to previously collected sensory data exceeds a predetermined threshold. In one example, a model is trained of the sensory data associated with images with the tag “horse back riding” and used to create a new activity context model. In another example, at least one of the sensory data corresponding to the images tagged with “horse back riding” is stored as an example for the activity “horse back riding”.

The context recognition circuitry 118 may be configured to cause location data to be transmitted to the network navigation apparatus 104. The location data may define a location of the client apparatus 102 at the time of capture of sensory data based upon which information (e.g., context information) transmitted to the network navigation apparatus 104 was derived. If the context recognition circuitry 118 derives information from captured sensory data and forwards the derived information to the network navigation apparatus 104 relatively contemporaneously with capture of the sensory data, the location may comprise a location of the client apparatus 102 when the information is transmitted to the network navigation apparatus 104. If, however, the context recognition circuitry 118 derives information and/or forwards derived information after some delay following capture of the sensory data, the context recognition circuitry 118 may determine a location of the client apparatus 102 at time of capture of the sensory data and store that location in association with the sensory data.

The modeling circuitry 128 of the network navigation apparatus 104 may be configured to receive context information and/or other information derived from captured sensory data that is transmitted by the client apparatus 102. When the modeling circuitry 128 receives raw sensory data or information that still needs to be at least partially processed to derive context information, the modeling circuitry 128 may be configured to derive context information from the received data. The modeling circuitry 128 may perform this derivation in accordance with any of the techniques discussed in connection with the context recognition circuitry 118.

The modeling circuitry 128 may be configured to maintain a context model. The context model may comprise location data and associated context information. The location data may define locations and/or routes between locations. The locations and/or routes may have associated context information. In this regard, the context information associated with a respective location or route may be derived from sensory data captured by one or more client apparatuses 102 when located at the respective location or route. Thus, for example, the context model may store context information defining ambient noises that have been heard at a location, activities that have been performed at a location, a number of people that have been present at a location, and/or the like. The context model may further include time-based context information associations for a location. For example, a first set of context information may be associated with a location that defines nighttime activities and/or ambient noises and a second set of context information may be associated with a location that defines daytime activities and/or ambient noises. As another example, context information associated with a location may be organized by date, time, season, and/or the like such that variation in a location context may be modeled. As another example, context information associated with a location may be organized by demographic aspects such as the age, gender, occupation, and/or hobbies of the user of the client apparatus 102 providing the data, such that variation across different user populations may be modeled and considered by the context navigation circuitry 130 when determining route(s). Context information associated with a location or route may be ranked by a rate of occurrence. For example, if vehicle noise has been detected at a location on one occasion and birds singing have been detected at a location on several occasions, birds singing may be ranked higher as an audio context for the location than vehicle noise. In this regard, birds singing may be the more likely or frequently occurring context and may be more prominently factored when a context-based navigation route including the location is derived.

The modeling circuitry 128 may be configured to update the context model with context information received from a client apparatus 102 and/or with context information derived from information received from a client apparatus 102. In this regard, the modeling circuitry 128 may be configured to associate the context information with a location and/or route at which the client apparatus 102 was located when the sensory data from which the context information was derived was captured. As has been discussed, indication of the location may have been provided to the network navigation apparatus 104 by the client apparatus 102. Accordingly, through participation of a plurality of client apparatuses 102, an accurate context model of real world locations may be developed, which may facilitate the provision of meaningful context-based navigation services to users.

In this regard, the context navigation circuitry 130 may be configured to utilize the context model to provide context-based navigation directions. The client navigation circuitry 120 may be configured to determine a starting location and a destination location. In one example, the starting location comprises a current location of the client apparatus 102 and the destination location may comprise a location selected by a user, such as via the user interface 116. As another example, the user may select both the starting location and the destination location. The context navigation circuitry 130 may provide the starting location and destination location to the network navigation apparatus 104.

The context navigation circuitry 130 may be configured to receive a starting location and destination location provided by a client apparatus 102. The context navigation circuitry 130 may be further configured to extract context information from the context model based at least in part upon one or more of the starting location or destination location. In this regard, the context navigation circuitry 130 may be configured to extract context information associated with the starting location, destination location, and/or one or more locations located in a path(s) between the starting location and destination location. The context navigation circuitry 130 may utilize the extracted context information to determine at least one route between the first location and the second location.

In this regard, the context navigation circuitry 130 may be configured to determine the at least one route based at least in part upon one or more context criterion such that the determined at least one route is associated with and/or traverses one or more locations associated with extracted context information that satisfies the context criterion. For example, a user may select a desired audio context, activity context, and/or visual context via the user interface 116 and the client navigation circuitry 120 may provide the desired context(s) to the network navigation apparatus 104. The context navigation circuitry 130 may then determine one or more routes that satisfy the desired context(s). As an example, the user may indicate a desire for a route that is suitable for running and is quiet. Accordingly, the context navigation circuitry 130 may utilize context information extracted from the context model to determine one or more routes between the starting location and destination location that are quiet and suitable for running.

As another example, the context criterion may be determined based at least in part upon a present context of the client apparatus 102. For example, when the client navigation circuitry 120 provides the starting and destination locations to the network navigation apparatus 104, current context information for the client apparatus 102 may also be provided. Thus, for example, if the current context information includes activity information indicating an activity of the user of the client apparatus 102 when making the navigation request, the context navigation circuitry 130 may determine one or more routes suitable for the user's activity. In this regard, if the user of the client apparatus 102 is determined to be bicycling based on the current context information, the context navigation circuitry 130 may determine one or more routes suitable for bicycling. As another example, if the current context information includes an audio context indicating that the client apparatus 102 is near running water, such as a stream, the context navigation circuitry 130 may determine one or more routes that are close to water related audio events.

The context criterion may alternatively be determined based both on a present context of the client apparatus 102 and on a desired context (e.g., a user-specified context). For example, if a user's present activity context is determined to be jogging, the user may be prompted to select an audio context for a desired route. In this regard, the user may be prompted to select whether the user wishes to use a route suitable for jogging that is quiet or a route suitable for jogging that is noisy. The context navigation circuitry 130 may then use the determined and desired contexts as context criteria for determining one or more routes.

The context navigation circuitry 130 may be additionally or alternatively configured to determine a context criterion based at least in part upon an historical user context for the client apparatus 102 and/or for a user thereof. In this regard, the context navigation circuitry 130 may be configured to maintain a history of one or more of contexts of navigation routes previously selected by a user of the client apparatus 102, previously collected context information for the client apparatus 102, and/or the like. Based on this historical user context information, the context navigation circuitry 130 may determine one or more preferred contexts for the user. For example, the context navigation circuitry 130 may determine that the user of the client apparatus 102 prefers to take routes suitable for cycling through a quiet environment with natural noises. Accordingly, in some embodiments, the context navigation circuitry 130 may use one or more preferred contexts determined through historical user context information as context criteria for determining one or more routes. The context navigation circuitry 130 may be configured to use the historical user context information in lieu of or in addition to one or more of a current context of the client apparatus, a current context of a user of the client apparatus, a user-specified context preference, or the like when determining one or more context criterion for determining one or more routes.

Additionally or alternatively, the context navigation circuitry 130 may not utilize a context criterion when determining one or more routes. In this regard, the context navigation circuitry 130 may utilize context information extracted from the context model to determine one or more routes between a first location and another location and provide those to the client apparatus 102 along with indications of their respective associated contexts. Accordingly, a user of a client apparatus 102 may select a route from a plurality of possible or suggested routes based on a desired context.

The context navigation circuitry 130 may be configured to consider additional or alternative contexts modeled in the context model when determining routes. For example, the context navigation circuitry 130 may consider time and/or situational context (e.g., time of day, day of year, season of year, and/or the like) when determining a route. Thus, if the context navigation circuitry 130 is determining a route for use during the summer, the context navigation circuitry 130 may consider context information collected during the summer, but not context information collected during winter. The context navigation circuitry 130 may further consider a popularity and/or crowd context, which may indicate how heavily traveled a route is and/or how many people are present in one or more locations along the route. As another example, the context navigation circuitry 130 may be configured to consider a weather context. For example, certain audio and/or activity contexts associated with a location may further be associated with a weather context. In this regard, an audio context and/or activity context for a location may be associated with sunny weather, but not with rainy weather. When considering a context for a location, the context navigation circuitry 130 may only consider a predefined number of most frequently observed contexts, so as to not skew route determinations with consideration of an outlying or rarely occurring context.

The context navigation circuitry 130 may provide the determined one or more routes to the client apparatus 102. The client navigation circuitry 120 may receive routes and present them to a user, such as by displaying the routes on a display of the user interface 116. The user may select a desired route and the client navigation circuitry 120 may utilize the route to provide navigational directions to the user so that the user may get to the destination location.

In addition to determining a route based on context information extracted from the context model, the context navigation circuitry 130 may also be configured to determine a location. For example, the context navigation circuitry 130 may be configured to determine a destination location satisfying a context criterion specified by a user of the client apparatus 102 and/or a context criterion determined based on a current context of the client apparatus 102. The navigation circuitry 130 may determine a route to such a determined location as described above.

In this regard, embodiments of the invention may provide for context based navigation services wherein routes and/or locations are identified for a user based on context criterion. Example context criterion used for determining locations and/or routes may include, for example:
places where people do certain activities, e.g. run (based on detected running activity)
quiet/loud places (audio context=low/high environment loudness)
places where birds sing (audio context=bird sounds)
places with animals (audio context=recognized animal sounds and/or visual context=recognized animal)
places with children (audio context=detected children sounds and/or visual context=recognized children)
places with vehicles (audio context=detected vehicle sounds and/or visual context=recognized vehicle)
Find a route to destination which goes through quiet parks (audio context=quiet environment, small audio energy, or the like)
Find a route through places with birds (audio context=bird sounds and/or visual context=recognized birds)
Find a route through places with many/few people (social context=few neighboring Bluetooth devices and/or visual context=recognized people and/or audio context=recognized people sounds)
Find a route suitable for cycling/skiing/running (based on detected activity)
Find a route suitable for slow walking (e.g., based on detected current activity context for the client apparatus 102 being walking at slow speed)
Find a popular route for bicycling on sunny summer days
Find a popular route taken during night-time from the city center to a particular building/area (which might give a hint on the routes people have considered to be the safest)
Find a place for jogging (activity context=jogging)
Find a place for cycling (activity context=cycling and/or visual context=recognized bicycle)
Find a place where there are children (audio context=children sounds and/or visual context=recognized children)
Find a place where people are happy (audio context=laughing sounds)
Find a place with men/women present (audio context=detected male/female sounds)
Find a route along which there has been many bear observations (visual context=recognized bear animal)
Find a place where there are many black cars/blue houses (visual context=recognized black car or blue house)
Find a place where there are many red flowers (visual context=recognized red flower)
Find a route along green areas (visual context=recognized green plants or trees or grass)

Accordingly, the navigational services provided by embodiments of the invention may be quite beneficial for pedestrian or other non-vehicular modes of navigation (e.g., bicycling, skateboarding, and/or the like) wherein a user may be exposed to audio ambiance and/or be engaged in some physical activity that requires particular consideration when determining a navigation route.

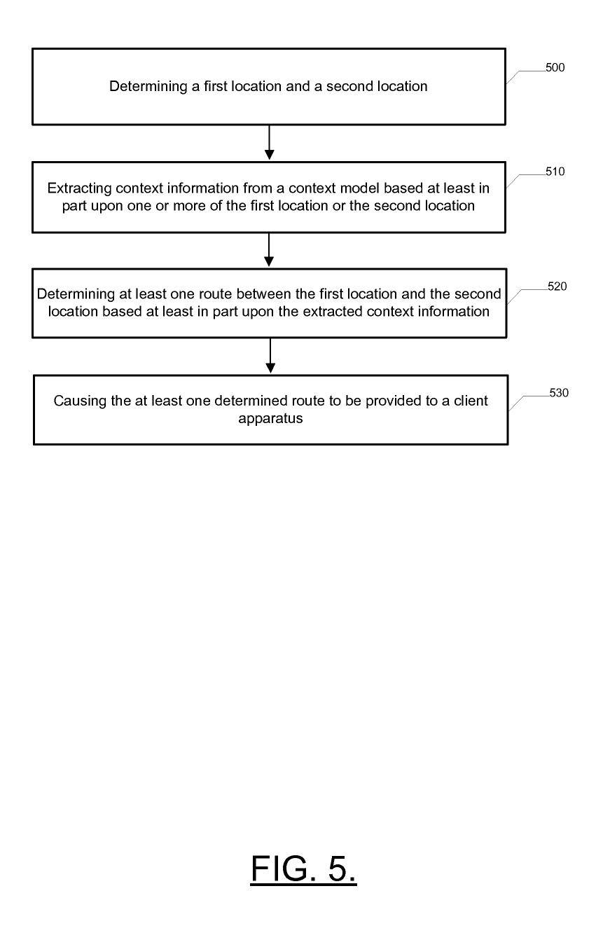

FIG. 5 illustrates a flowchart according to an example method for providing context-based navigation services according to an example embodiment of the invention. In this regard, FIG. 5 illustrates operations that may, for example, be performed at the network navigation apparatus 104. The operations illustrated in and described with respect to FIG. 5 may, for example, be performed by and/or under control of one or more of the processor 122, memory 124, communication interface 126, modeling circuitry 128, or the context navigation circuitry 130. Operation 500 may comprise determining a first location and a second location. Operation 510 may comprise extracting context information from a context model based at least in part upon one or more of the first location or the second location. Operation 520 may comprise determining at least one route between the first location and the second location based at least in part upon the extracted context information. Operation 530 may comprise causing the at least one determined route to be provided to a client apparatus 102.

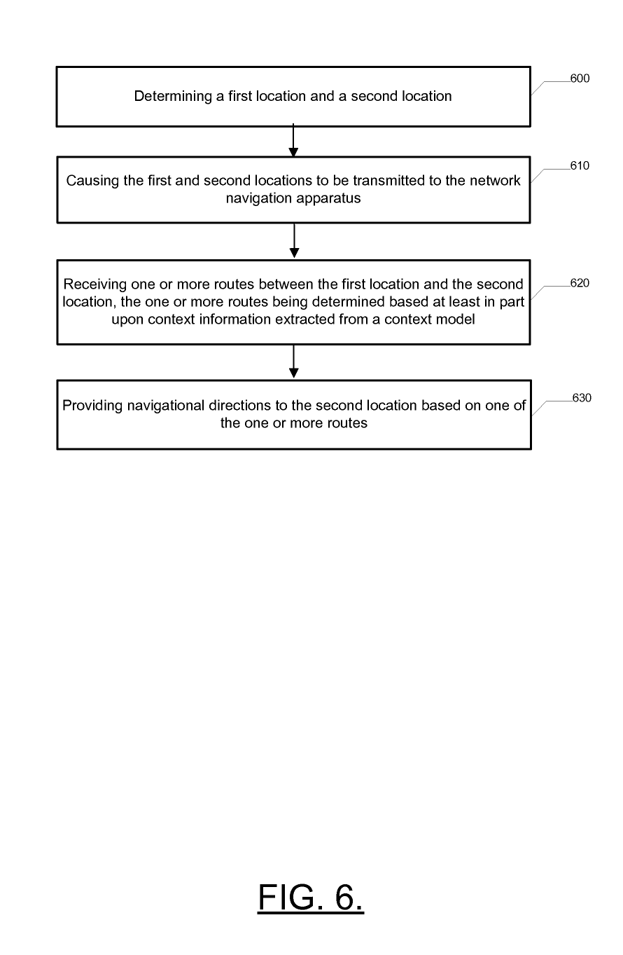

FIG. 6 illustrates a flowchart according to an example method for providing context-based navigation services according to an example embodiment of the invention. In this regard, FIG. 6 illustrates operations that may, for example, be performed at the client apparatus 102. The operations illustrated in and described with respect to FIG. 6 may, for example, be performed by and/or under control of one or more of the processor 110, memory 112, communication interface 114, user interface 116, context recognition circuitry 118, or client navigation circuitry 120. Operation 600 may comprise determining a first location and a second location. Operation 610 may comprise causing the first and second locations or indication(s) thereof to be transmitted to the network navigation apparatus 104. Operation 620 may comprise receiving one or more routes between the first location and the second location, the one or more routes being determined based at least in part upon context information extracted from a context model. Operation 630 may comprise providing navigational directions to the second location based on one of the one or more routes.

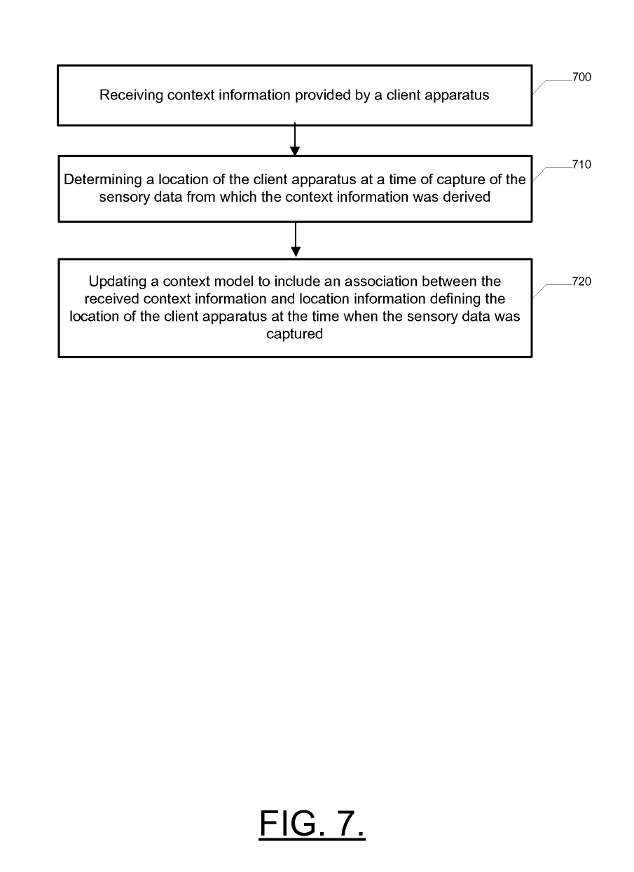

FIG. 7 illustrates a flowchart according to an example method for updating a context model according to an example embodiment of the invention. In this regard, FIG. 7 illustrates operations that may, for example, be performed at the network navigation apparatus 104. The operations illustrated in and described with respect to FIG. 7 may, for example, be performed by and/or under control of one or more of the processor 122, memory 124, communication interface 126, modeling circuitry 128, or the context navigation circuitry 130. Operation 700 may comprise receiving context information provided by a client apparatus 102. Operation 710 may comprise determining a location of the client apparatus at a time of capture of the sensory data from which the context information was derived. Operation 720 may comprise updating a context model to include an association between the received context information and location information defining the location of the client apparatus at the time when the sensory data was captured.

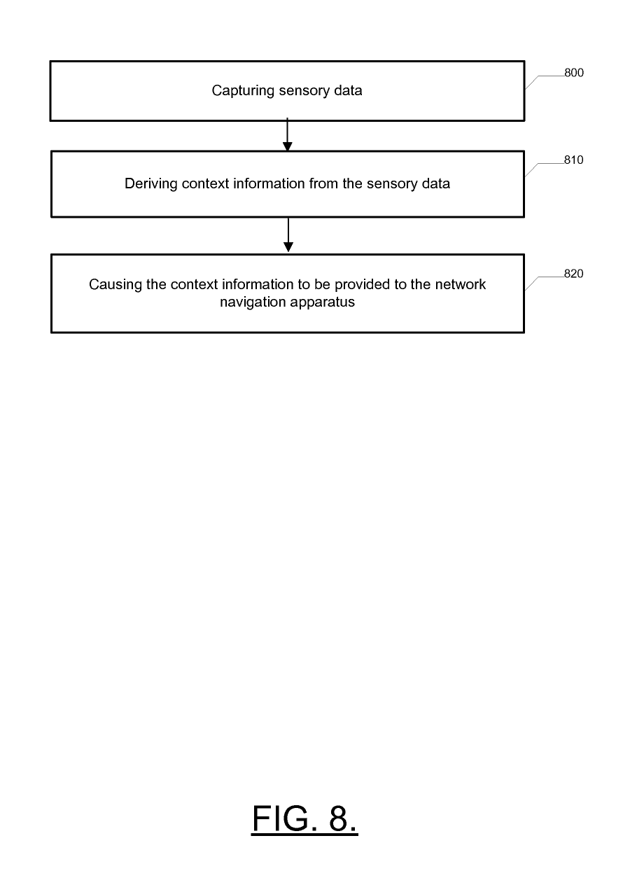

FIG. 8 illustrates a flowchart according to an example method for providing context information to a network navigation apparatus 104 according to an example embodiment of the invention. In this regard, FIG. 8 illustrates operations that may, for example, be performed at the client apparatus 102. The operations illustrated in and described with respect to FIG. 8 may, for example, be performed by and/or under control of one or more of the processor 110, memory 112, communication interface 114, user interface 116, context recognition circuitry 118, or client navigation circuitry 120. Operation 800 may comprise capturing sensory data. Operation 810 may comprise deriving context information from the sensory data. Operation 820 may comprise causing the context information to be provided to the network navigation apparatus 104.

FIGS. 5-8 are flowcharts of a system, method, and computer program product according to example embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories (e.g., memory 112 and/or memory 124) on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, client apparatus 102 and/or network navigation apparatus 104) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (e.g., the processor 110 and/or processor 122) may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

In a first example embodiment, a method is provided, which comprises determining a first location and a second location. The method of this embodiment further comprises extracting context information from a context model based at least in part upon one or more of the first location or the second location. The extracted context information of this embodiment comprises one or more of audio context information, activity context information, social context information, or visual context information. The method of this embodiment additionally comprises determining at least one route between the first location and the second location based at least in part upon the extracted context information. The method of this embodiment also comprises causing the at least one determined route to be provided to a client apparatus.

The context model may comprise location data and associated context information. The location data may define one or more of a plurality of locations having associated context information or a plurality of routes between locations having associated context information. The context information associated with a respective location or route may be derived from sensory data captured by one or more client apparatuses when located at the respective location or route.

Determining the at least one route may comprise determining the at least one route based at least in part upon a context criterion. The determined at least one route may be determined such that the at least one route is associated with or traverses one or more locations associated with a subset of the extracted context information that satisfies the context criterion. The context criterion may be determined based at least in part upon one or more of a current context of the client apparatus, a current context of a user of the client apparatus, a user-specified context preference, or historical user context information.

The method may further comprise updating the context model with collected context information. The collected context information may be derived from sensory data captured by a client apparatus. Updating the context model may comprise determining a location of the client apparatus at a time when the sensory data was captured. Updating the context model may further comprise updating the context model to include an association between the collected context information and location information defining the determined location of the client apparatus at the time when the sensory data was captured. The collected context information may comprise one or more of audio context information derived from audio captured by the client apparatus, activity context information derived from sensory information captured by the client apparatus, social context information derived from sensory information captured by the client apparatus, or visual context information derived from one or more of an image or video captured by the client apparatus.

In another example embodiment, an apparatus is provided. The apparatus of this embodiment comprises at least one processor and at least one memory storing computer program code, wherein the at least one memory and stored computer program code are configured to, with the at least one processor, cause the apparatus to at least determine a first location and a second location. The at least one memory and stored computer program code are configured to, with the at least one processor, further cause the apparatus of this embodiment to extract context information from a context model based at least in part upon one or more of the first location or the second location. The extracted context information of this embodiment comprises one or more of audio context information, activity context information, social context information, or visual context information. The at least one memory and stored computer program code are configured to, with the at least one processor, additionally cause the apparatus of this embodiment to determine at least one route between the first location and the second location based at least in part upon the extracted context information. The at least one memory and stored computer program code are configured to, with the at least one processor, also cause the apparatus of this embodiment to cause the at least one determined route to be provided to a client apparatus.

The context model may comprise location data and associated context information. The location data may define one or more of a plurality of locations having associated context information or a plurality of routes between locations having associated context information. The context information associated with a respective location or route may be derived from sensory data captured by one or more client apparatuses when located at the respective location or route.

The at least one memory and stored computer program code may be configured to, with the at least one processor, cause the apparatus to determine the at least one route by determining the at least one route based at least in part upon a context criterion. The determined at least one route may be determined such that the at least one route is associated with or traverses one or more locations associated with a subset of the extracted context information that satisfies the context criterion the context criterion. The context criterion may be determined based at least in part upon one or more of a current context of the client apparatus, a current context of a user of the client apparatus, a user-specified context preference, or historical user context information.

The at least one memory and stored computer program code may be configured to, with the at least one processor, further cause the apparatus to update the context model with collected context information. The collected context information may be derived from sensory data captured by a client apparatus. The at least one memory and stored computer program code may be configured to, with the at least one processor, cause the apparatus to update the context model by determining a location of the client apparatus at a time when the sensory data was captured and updating the context model to include an association between the collected context information and location information defining the determined location of the client apparatus at the time when the sensory data was captured. The collected context information may comprise one or more of audio context information derived from audio captured by the client apparatus, activity context information derived from sensory information captured by the client apparatus, social context information derived from sensory information captured by the client apparatus, or visual context information derived from one or more of an image or video captured by the client apparatus.

In another example embodiment, a computer program product is provided. The computer program product of this embodiment includes at least one computer-readable storage medium having computer-readable program instructions stored therein. The program instructions of this embodiment comprise program instructions configured to determine a first location and a second location. The program instructions of this embodiment further comprise program instructions configured to extract context information from a context model based at least in part upon one or more of the first location or the second location. The extracted context information of this embodiment comprises one or more of audio context information, activity context information, social context information, or visual context information. The program instructions of this embodiment also comprise program instructions configured to determine at least one route between the first location and the second location based at least in part upon the extracted context information. The program instructions of this embodiment additionally comprise program instructions configured to cause the at least one determined route to be provided to a client apparatus.

The context model may comprise location data and associated context information. The location data may define one or more of a plurality of locations having associated context information or a plurality of routes between locations having associated context information. The context information associated with a respective location or route may be derived from sensory data captured by one or more client apparatuses when located at the respective location or route.

The program instructions configured to determine the at least one route may comprise program instructions configured to determine the at least one route based at least in part upon a context criterion. The determined at least one route may be determined such that the at least one route is associated with or traverses one or more locations associated with a subset of the extracted context information that satisfies the context criterion. The context criterion may be determined based at least in part upon one or more of a current context of the client apparatus, a current context of a user of the client apparatus, a user-specified context preference, or historical user context information.

The computer program product may further comprise program instructions configured to update the context model with collected context information. The collected context information may be derived from sensory data captured by a client apparatus. The program instructions configured to update the context model may comprise program instructions configured to determine a location of the client apparatus at a time when the sensory data was captured. The program instructions configured to update the context model may further comprise program instructions configured to update the context model to include an association between the collected context information and location information defining the determined location of the client apparatus at the time when the sensory data was captured. The collected context information may comprise one or more of audio context information derived from audio captured by the client apparatus, activity context information derived from sensory information captured by the client apparatus, social context information derived from sensory information captured by the client apparatus, or visual context information derived from one or more of an image or video captured by the client apparatus.

In another example embodiment, a method is provided, which comprises determining a first location and a second location. The method of this embodiment further comprises causing an indication of the first location and the second location to be provided to a network navigation apparatus. The method of this embodiment additionally comprises receiving one or more routes between the first location and the second location. The one or more routes of this embodiment are determined based at least in part upon context information extracted from a context model. The context information of this embodiment comprises one or more of audio context information, activity context information, social context information, or visual context information.

The context model may comprise location data and associated context information. The location data may define one or more of a plurality of locations having associated context information or a plurality of routes between locations having associated context information. The context information associated with a respective location or route may be derived from sensory data captured by one or more client apparatuses when located at the respective location or route.

The method may further comprise capturing sensory data. The method may additionally comprise causing information derived from the sensory data to be transmitted to the network navigation apparatus. The network navigation apparatus may be configured to update the context model based at least in part upon the provided information.

The method may further comprise deriving context information from the sensory data. The information derived from the sensory data may comprise the derived context information. Capturing sensory data may comprise one or more of capturing audio data; capturing an accelerometer signal; capturing location data (e.g., capturing a signal of a positioning system); capturing an image; capturing a video; determining a signal strength of an access point (e.g., a base station) of a network (e.g., a cellular communication network); or determining a number of electronic devices within signaling range of a proximity-based communications technology based on one or more received indications of electronic devices via the proximity-based communications technology.

In another example embodiment, an apparatus is provided. The apparatus of this embodiment comprises at least one processor and at least one memory storing computer program code, wherein the at least one memory and stored computer program code are configured to, with the at least one processor, cause the apparatus to at least determine a first location and a second location. The at least one memory and stored computer program code are configured to, with the at least one processor, further cause the apparatus of this embodiment to cause an indication of the first location and the second location to be provided to a network navigation apparatus. The at least one memory and stored computer program code are configured to, with the at least one processor, additionally cause the apparatus of this embodiment to receive one or more routes between the first location and the second location. The one or more routes of this embodiment are determined based at least in part upon context information extracted from a context model. The context information of this embodiment comprises one or more of audio context information, activity context information, social context information, or visual context information.

The context model may comprise location data and associated context information. The location data may define one or more of a plurality of locations having associated context information or a plurality of routes between locations having associated context information. The context information associated with a respective location or route may be derived from sensory data captured by one or more client apparatuses when located at the respective location or route.

The at least one memory and stored computer program code may be configured to, with the at least one processor, further cause the apparatus to capture sensory data. The at least one memory and stored computer program code may be configured to, with the at least one processor, additionally cause the apparatus to cause information derived from the sensory data to be transmitted to the network navigation apparatus. The network navigation apparatus may be configured to update the context model based at least in part upon the provided information.

The at least one memory and stored computer program code may be configured to, with the at least one processor, further cause the apparatus to derive context information from the sensory data. The information derived from the sensory data comprises the derived context information. The at least one memory and stored computer program code may be configured to, with the at least one processor, cause the apparatus to capture sensory data by one or more of capturing audio data; capturing an accelerometer signal; capturing location data (e.g., capturing a signal of a positioning system); capturing an image; capturing a video; determining a signal strength of an access point (e.g., a base station) of a network (e.g., a cellular communication network); or determining a number of electronic devices within signaling range of a proximity-based communications technology based on one or more received indications of electronic devices via the proximity-based communications technology.

The apparatus may comprise or be embodied on a mobile phone. The mobile phone may comprise user interface circuitry and user interface software stored on one or more of the at least one memory. The user interface circuitry and user interface software may be configured to facilitate user control of at least some functions of the mobile phone through use of a display. The user interface circuitry and user interface software may be further configured to cause at least a portion of a user interface of the mobile phone to be displayed on the display to facilitate user control of at least some functions of the mobile phone.

In another example embodiment, a computer program product is provided. The computer program product of this embodiment includes at least one computer-readable storage medium having computer-readable program instructions stored therein. The program instructions of this embodiment comprise program instructions configured to determine a first location and a second location. The program instructions of this embodiment further comprise program instructions configured to cause an indication of the first location and the second location to be provided to a network navigation apparatus. The program instructions of this embodiment additionally comprise program instructions configured to cause receipt of one or more routes between the first location and the second location. The one or more routes of this embodiment are determined based at least in part upon context information extracted from a context model. The context information of this embodiment comprises one or more of audio context information, activity context information, social context information, or visual context information.

The context model may comprise location data and associated context information. The location data may define one or more of a plurality of locations having associated context information or a plurality of routes between locations having associated context information. The context information associated with a respective location or route may be derived from sensory data captured by one or more client apparatuses when located at the respective location or route.

The computer program product may further comprise program instructions configured to capture sensory data. The computer program product may additionally comprise program instructions configured to cause information derived from the sensory data to be transmitted to the network navigation apparatus. The network navigation apparatus may be configured to update the context model based at least in part upon the provided information.

The computer program product may further comprise program instructions configured to derive context information from the sensory data. The information derived from the sensory data may comprise the derived context information. The program instructions configured to capture sensory data may comprise program instructions configured to capture sensory data by one or more of capturing audio data; capturing an accelerometer signal; capturing location data (e.g., capturing a signal of a positioning system); capturing an image; capturing a video; determining a signal strength of an access point (e.g., a base station) of a network (e.g., a cellular communication network); or determining a number of electronic devices within signaling range of a proximity-based communications technology based on one or more received indications of electronic devices via the proximity-based communications technology.

As such, then, some embodiments of the invention provide several advantages to network service providers, computing devices accessing network services, and computing device users. In this regard, systems, methods, apparatuses, and computer program products are provided that provide navigation services to a user based on context information. Example embodiments of the invention provide navigation services based on audio context information, activity context information, time context information, social context information, visual context information, and/or the like. Embodiments of the invention provide for collection of context information associated with one or more locations from client apparatuses. The collected context information is used in some example embodiments to generate a context model comprising activity contexts, audio contexts, social contexts, visual contexts, and/or the like associated with locations. Example embodiments of the invention utilize the context model to determine suggested navigation routes for users based upon a context(s) suggested to or requested by the user. Accordingly, users may receive more meaningful navigation services that may include routes selected by route context. These context-based navigation services may be particularly beneficial to pedestrian users and/or users engaging in other non-motorized travel, such as, for example, cyclists, skiers, and/or the like.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
determining a first location and a second location;
extracting context information from a context model based at least in part upon one or more of the first location or the second location, the extracted context information comprising one or more of audio context information, activity context information, social context information, or visual context information;
determining, by a processor, at least one route between the first location and the second location based at least in part upon the extracted context information; and
causing the at least one determined route to be provided.

2. The method of claim 1, wherein the context model comprises location data and associated context information, wherein the location data defines one or more of a plurality of locations having associated context information or a plurality of routes between locations having associated context information, and wherein the context information associated with a respective location or route is derived from sensory data captured by one or more client apparatuses when located at the respective location or route.

3. The method of claim 1, wherein determining the at least one route comprises determining the at least one route based at least in part upon a context criterion, wherein the determined at least one route is associated with or traverses one or more locations associated with a subset of the extracted context information that satisfies the context criterion.

4. The method of claim 3, wherein the context criterion is determined based at least in part upon one or more of a current context of a client apparatus, a current context of a user of the client apparatus, a user-specified context preference, or historical user context information.

5. The method of claim 1, further comprising updating the context model with collected context information, the collected context information derived from sensory data captured by a client apparatus.

6. The method of claim 5, wherein updating the context model comprises:
determining a location of the client apparatus at a time when the sensory data was captured; and
updating the context model to include an association between the collected context information and location information defining the determined location of the client apparatus at the time when the sensory data was captured.

7. An apparatus comprising at least one processor and at least one memory storing computer program code, wherein the at least one memory and stored computer program code are configured to, with the at least one processor, cause the apparatus to at least:
determine a first location and a second location;
extract context information from a context model based at least in part upon one or more of the first location or the second location, the extracted context information comprising one or more of audio context information, activity context information, social context information, or visual context information;
determine at least one route between the first location and the second location based at least in part upon the extracted context information; and
cause the at least one determined route to be provided.

8. The apparatus of claim 7, wherein the context model comprises location data and associated context information, wherein the location data defines one or more of a plurality of locations having associated context information or a plurality of routes between locations having associated context information, and wherein the context information associated with a respective location or route is derived from sensory data captured by one or more client apparatuses when located at the respective location or route.

9. The apparatus of claim 7, wherein the at least one memory and stored computer program code are configured to, with the at least one processor, cause the apparatus to determine the at least one route by determining the at least one route based at least in part upon a context criterion, wherein the determined at least one route is associated with or traverses one or more locations associated with a subset of the extracted context information that satisfies the context criterion.

10. The apparatus of claim 9, wherein the context criterion is determined based at least in part upon one or more of a current context of a client apparatus, a current context of a user of the client apparatus, a user-specified context preference, or historical user context information.

11. The apparatus of claim 7, wherein the at least one memory and stored computer program code are configured to, with the at least one processor, further cause the apparatus to update the context model with collected context information, the collected context information derived from sensory data captured by a client apparatus.

12. The apparatus of claim 11, wherein the at least one memory and stored computer program code are configured to, with the at least one processor, cause the apparatus to update the context model by:
determining a location of the client apparatus at a time when the sensory data was captured; and
updating the context model to include an association between the collected context information and location information defining the determined location of the client apparatus at the time when the sensory data was captured.

13. A method comprising:
determining a first location and a second location;
causing an indication of the first location and the second location to be provided to a network navigation apparatus; and
receiving, by a processor, one or more routes between the first location and the second location, the one or more routes being determined based at least in part upon context information extracted from a context model, the context information comprising one or more of audio context information, activity context information, social context information, or visual context information.

14. The method of claim 13, wherein the context model comprises location data and associated context information, wherein the location data defines one or more of a plurality of locations having associated context information or a plurality of routes between locations having associated context information, and wherein the context information associated with a respective location or route is derived from sensory data captured by one or more client apparatuses when located at the respective location or route.

15. The method of claim 13, further comprising:
causing capture of sensory data; and
causing information derived from the sensory data to be transmitted to the network navigation apparatus, the network navigation apparatus being configured to update the context model based at least in part upon the provided information.

16. The method of claim 15, further comprising:
deriving context information from the sensory data; and
wherein the information derived from the sensory data comprises the derived context information.

17. An apparatus comprising at least one processor and at least one memory storing computer program code, wherein the at least one memory and stored computer program code are configured to, with the at least one processor, cause the apparatus to at least:
determine a first location and a second location;
cause an indication of the first location and the second location to be provided to a network navigation apparatus; and
receive one or more routes between the first location and the second location, the one or more routes being determined based at least in part upon context information extracted from a context model, the context information comprising one or more of audio context information, activity context information, social context information, or visual context information.

18. The apparatus of claim 17, wherein the context model comprises location data and associated context information, wherein the location data defines one or more of a plurality of locations having associated context information or a plurality of routes between locations having associated context information, and wherein the context information associated with a respective location or route is derived from sensory data captured by one or more client apparatuses when located at the respective location or route.

19. The apparatus of claim 17, wherein the at least one memory and stored computer program code are configured to, with the at least one processor, further cause the apparatus to:
cause capture of sensory data; and
cause information derived from the sensory data to be transmitted to the network navigation apparatus, the network navigation apparatus being configured to update the context model based at least in part upon the provided information.

20. The apparatus of claim 19, wherein the at least one memory and stored computer program code are configured to, with the at least one processor, further cause the apparatus to:
derive context information from the sensory data; and
wherein the information derived from the sensory data comprises the derived context information.

21. The apparatus of claim 17, wherein the apparatus comprises or is embodied on a mobile phone, the mobile phone comprising user interface circuitry and user interface software stored on one or more of the at least one memory; wherein the user interface circuitry and user interface software are configured to:
facilitate user control of at least some functions of the mobile phone through use of a display; and
cause at least a portion of a user interface of the mobile phone to be displayed on the display to facilitate user control of at least some functions of the mobile phone.
